(19) United States
(12) Patent Application Publication
(10) Pub. No.: US 2002/0198314 A1
(43) Pub. Date: Dec. 26, 2002

(54) Powder slurry and method for producing a coloured and or decorative effect multi layered coating on a primed or unprimed

(76) Inventors: Uwe Meisenburg, Duisburg (DE); Hubert Baumgart, Munster (DE); Karl-Heinz Joost, Drensteinfurt (DE); Sandra Hasse, Hamm (DE)

Correspondence Address: BASF CORPORATION, ANNE GERRY SABOURIN, 26701 TELEGRAPH ROAD, SOUTHFIELD, MI, 48034-2442, US

(21) Appl. No.: 10/130,648

(22) PCT Filed: Dec. 5, 2000
(86) PCT No.: PCT/EP00/12191

(30) Foreign Application Priority Data
Dec. 6, 1999 (DE) 199 58 726.4

(51) Int. Cl. B05D 1/36; C08K 3/00

(52) U.S. Cl. 524/589; 427/407.1

(57) ABSTRACT

The invention relates to a method for producing a colored and/or decorative-effect multi-layered coating on a primed or unprimed substrate. According to

said method, a base lacquer layer and a clear lacquer layer are applied one on top of another, the clear lacquer containing an aqueous, blocked

isocyanate group which in turn consists of or contains a polyurethane dispersion. The polyurethane consists of aliphatic polyisocyanates, compounds

containing functional groups reactive to isocyanate and bonds which can be activated by actinic radiation, low-molecular aliphatic compounds containing

functional groups reactive to isocyanate and dispersing functional groups, in addition to neutralizing agents for said dispersing functional groups. The

blocked isocyanate groups are introduced into the polyurethane dispersion by adding blocked polyisocyanates and/or by reacting blocking agents for

isocyanate groups and/or compounds containing blocked isocyanate groups with the polyurethane prepolymers containing isocyanate groups. The

aqueous clear lacquer can be a powder slurry.

The present invention relates to a novel process for producing a multicoat color and/or effect paint system on a primed or unprimed substrate. The present invention further relates to a novel powder slurry. Automobile manufacturers and their customers are subjecting automotive OEM finishes and refinishes to increasingly stringent requirements in terms of corrosion resistance, mechanical stability—resistance to scratching by wash brushes, for example—stonechip resistance, and the overall visual appearance, including the optical effects. As is known, these requirements are met to a certain extent by a multicoat paint system comprising, above one another on a metal bodywork panel, an electrodeposition coat, a surfacer coat or antistonechip primer coat, and a multicoat color and/or effect paint system composed of a color and/or effect basecoat and at least one clearcoat.

In addition, however, the paint systems are also required to meet the environmental requirements, which have risen continuously in recent years, such as the reduction in the amount of organic solvents, or complete absence of solvent.

In the course of these developments, aqueous coating materials have gradually been able to establish themselves. For instance, the electrocoat materials have for a long time already been virtually free from volatile organic constituents, especially organic solvents. Likewise, aqueous coating materials based on polyurethanes are available which are used to produce surfacer coats or antistonechip primer coats (cf. patents DE-A-40 05 961 and EP-A-0 548 873).

The use of aqueous basecoat materials as well, as described for example in patent DE-C-197 22 862, has made significant progress and persistently reduced the emissions of volatile organic constituents.

Also now available are solvent-free or substantially solvent-free clearcoat materials such as aqueous two-component (2K) or multicomponent (3K, 4K) clearcoats, powder clearcoats, powder slurry clearcoats, or liquid, solvent-free clearcoats curable with actinic radiation (100% systems).

The actinic radiation may comprise electromagnetic radiation such as visible light, UV light or X-rays, or corpuscular radiation such as electron beams.

Aqueous two-component (2K) or multicomponent (3K, 4K) clearcoats are disclosed, for example, in the German patent DE-A-44 21 823. Essential constituents of two-component (2K) or multicomponent (3K, 4K) clearcoats are known to comprise hydroxyl-containing binders and polyisocyanate crosslinking agents, which must be stored separately prior to their use.

Powder clearcoats are known, for example, from the German patent DE-A-42 22 194 or from the BASF Lacke+Farben AG product information leaflet “Pulverlacke” [powder coatings], 1990. The familiar essential constituents of powder clearcoats are binders containing epoxide groups and crosslinking agents comprising polycarboxylic acids.

Powder slurry clearcoats are known, for example, from the U.S. Pat. No. 4,268,542, the international patent application WO 96/32452, and the German patent applications DE-A-195 18 392.4 and DE-A-196 13 547, or are described in the German patent application DE-A-198 14 471.7, unpublished at the priority date of the present specification. Powder slurry clearcoats comprise, as is known, powder clearcoats in dispersion in an aqueous medium.

Clearcoats curable with actinic radiation are disclosed, for example, in the patents EP-A-0 540 884, EP-A-0 568 967, and U.S. Pat. No. 4,675,234. Their familiar constituents are compounds of low molecular mass, oligomeric compounds and/or polymeric compounds which are curable with actinic light and/or electron beams, preferably radiation-curable binders, based in particular on ethylenically unsaturated prepolymers and/or ethylenically unsaturated oligomers; if desired, one or more reactive diluents; and, if desired, one or more photoinitiators. Examples of suitable radiation-curable binders are (meth)acryloyl-functional (meth)acrylic copolymers, polyether acrylates, polyester acrylates, unsaturated polyesters, epoxy acrylates, urethane acrylates, amino acrylates, melamine acrylates, silicone acrylates, and the corresponding methacrylates. It is preferred to use binders which are free from aromatic structural units.

The European patent application EP-A-0 928 800 discloses a dual-cure coating material—curable thermally and with actinic radiation—comprising a urethane (meth)acrylate containing free isocyanate groups and (meth)acryloyl groups, a photoinitiator, and an isocyanate-reactive compound, especially a polyol or polyamine. This dual-cure coating material affords the opportunity to vary the profiles of properties of the coating material and coating and to tailor them to different end uses.

The disadvantage of the known dual-cure coating materials is that they are two-component systems, where the constituents containing free isocyanate groups must be stored separately from the constituents containing isocyanate-reactive groups in the absence of water until the time of their application, in order to prevent premature crosslinking. This, however, requires a high level of technical and planning effort for storage, preparation, and application.

In the context of the production of multicoat color and/or effect paint systems, the known aqueous basecoats and clearcoats are processed preferably by the wet-on-wet technique. In the wet-on-wet technique, as is known, a basecoat material is applied to a primed or unprimed substrate, after which the resultant basecoat film is dried, overcoated with a clearcoat material, and the resultant clearcoat film is cured together with the basecoat film, so giving the multicoat paint system composed of color and/or effect basecoat and protective clearcoat.

In the context of the wet-on-wet technique, the individual types of clearcoat have specific strengths and weaknesses.

The aqueous clearcoats, for instance, may penetrate the dried aqueous basecoat film during or after their application. Powder clearcoats may not flow out sufficiently in the course of curing, leading to structured surfaces.

After they have been cured, clearcoats based on two-component (2K) or multicomponent (3K, 4K) clearcoat materials are stable to weathering but often not sufficiently abrasion-resistant. Clearcoats curable with actinic radiation often exhibit severe shrinkage in the course of their curing, leading to delamination as a result of internal stresses. Moreover, following application to substrates of relatively complex shape, they may be cured inadequately in the shadow regions. Powder slurry clearcoats are more or less incompatible with some frequently used aqueous basecoats, which may lead to cracking (mud cracking) in the multicoat paint system and to delamination of the coats.

The German patent application DE-A-196 45 761 discloses hydrophilic self-crosslinking polyurethanes containing olefinically unsaturated groups and terminal blocked isocyanate groups. The blocking agents therein, however, are not specified in detail. These known hydrophilic self-crosslinking polyurethanes are used to prepare graft copolymers by the emulsion polymerization method. The resulting dispersions of the graft copolymers are used to prepare aqueous basecoats, and not clearcoats. The production of multicoat color and/or effect paint systems by the wet-on-wet technique, where basecoat films are overcoated with clearcoat films and then the two films are cured together, is not addressed in the patent application. Nor is there any description in the patent application of the combination of thermal curing and curing with actinic radiation (dual cure).

German patent DE-C-197 22 862 discloses an externally crosslinking graft copolymer obtainable by polymerizing olefinically unsaturated monomers in a dispersion of an olefinically unsaturated polyurethane containing hydrophilic functional groups and containing on average per molecule from 0.05 to 1.1 polymerizable, pendant and/or terminal double bonds. The known externally crosslinking graft copolymers of DE-C-197 22 862 are in the form of primary dispersions and are highly suitable for preparing aqueous externally crosslinking coating materials, especially aqueous basecoats. They may include blocked isocyanates as crosslinking agents. The externally crosslinking aqueous basecoats may be used with advantage to produce multicoat color and/or effect paint systems of the wet-on-wet technique. The patent, however, does not describe the use of the primary dispersions to prepare clearcoats which can be cured thermally and with actinic radiation.

In the context of the present invention, the term “self-crosslinking” refers to the capacity of a binder (regarding the term, cf. R\ddot{m}pp Lexikon Lacke und Druckfarben, Georg Thieme Verlag, Stuttgart, New York, 1998 “binders”, pages 73 and 74) to undergo crosslinking reactions with itself. This requires that the binders already contain both kinds of complementary reactive functional groups which are necessary for crosslinking. “Externally crosslinking”, on the other hand, is a term used for those coating materials in which one kind of the complementary reactive functional groups is present in the binder and the other kind in a curing or crosslinking agent. For further details, refer to R\ddot{m}pp Lexikon Lacke und Druckfarben, Georg Thieme Verlag, Stuttgart, New York, 1998 “curing”, pages 274 to 276, especially bottom of page 275.

In the German patent application DE 199 47 054.5, unpublished at the priority date of the present specification, a description is given of a clearcoat which is curable thermally and with actinic radiation and is based on an aqueous polyurethane dispersion containing hydroxyl groups, blocked isocyanate groups and olefinically unsaturated groups, and dispersive ionic groups. The use of these clearcoats in the context of the wet-on-wet technique is not described therein.

The German patent application DE-A-199 08 013.5, unpublished at the priority date of the present specification, describes a pseudoplastic powder slurry curable with actinic radiation and thermally, comprising solid spherical particles with an average size of from 0.8 to 20 μm and a maximum size of 30 μm, the powder clearcoat slurry containing from 0.05 to 1 meq/g of ion-forming dispersive groups, corresponding to an average acid number or amine number of from 3 to 56 g KOH/g solids (MEQ acid or amine of from 0.05 to 1.0 meq/g solids), preferably up to 28 (MEQ acid or amine: 0.5), and in particular up to 17 (MEQ acid or amine: 0.3), having a neutralizing agent content of from 0.05 to 1 meq/g and a viscosity of (i) from 50 to 1000 mPas at a shear rate of 1000 s⁻¹, (ii) from 150 to 8000 mPas at a shear rate of 10 s⁻¹, and (iii) from 180 to 12 000 mPas at a shear rate of 1 s⁻¹. The dispersive groups are introduced into the powder clearcoat slurry by means of separate, thermally crosslinkable binders.

The German patent application DE-A-199 08 018.6, unpublished at the priority date of the present specification, describes a dual-cure powder clearcoat slurry comprising constituents containing both groups (A) which may be activated with actinic radiation and complementary reactive functional groups (B) which undergo thermal crosslinking reactions, such as hydroxyl groups/blocked isocyanate groups or carboxyl groups/epoxide groups. The amount of acid groups in these constituents, however, is not specified. Furthermore, they serve primarily not to disperse the constituents but instead to crosslink them.

Accordingly, there continues to be a need for a process for producing multicoat color and/or effect paint systems that no longer has the disadvantages of the prior art but instead reliably and safely provides multicoat paint systems which, as far as color, effect, gloss, and DOI (distinctness of the reflected image) are concerned, are of the utmost optical quality, have a smooth, structureless, hard, flexible, and scratch-resistant surface, are resistant to weathering, chemicals and etching, do not yellow, and show no cracking or delamination of the coats.

It is an object of the present invention to meet this demand.

The invention accordingly provides the novel process for producing a multicoat color and/or effect paint system on a primed or unprimed substrate wherein a basecoat film and at least one clearcoat film are applied one atop the other, at least one of the clearcoat materials comprising or consisting of at least one aqueous polyurethane dispersion which contains blocked isocyanate groups and which has an acid number of from 5.0 to 100 mg KOH/g dispersion, the polyurethane contained in the polyurethane dispersion being composed of

A) at least one aliphatic polyisocyanate having an isocyanate functionality of from 2.0 to 6.0,

B) at least one compound containing at least one isocyanate-reactive functional group and at least one bond which can be activated with actinic radiation,

C) at least one low molecular mass aliphatic compound containing at least two isocyanate-reactive functional groups,

D) at least one compound containing at least one isocyanate-reactive functional group and at least one dispersive functional group,

E) at least one neutralizing agent for the dispersive functional groups of the compound D), and, if desired,

G) at least one compound other than compounds B) to E), containing an isocyanate-reactive functional group,

and the blocked isocyanate groups being introduced into the polyurethane dispersion

1. by adding at least one blocked polyisocyanate before, during and/or after the preparation of the polyurethane and/or

2. by way of the reaction of at least one blocking agent F) for isocyanate groups and/or at least one compound F) containing at least one blocked isocyanate group and one isocyanate-reactive group with the polyurethane prepolymers containing isocyanate groups that result from the reaction of a stoichiometric excess of the compounds A) with the compounds B) and also, where appropriate, C) and G) and also with an amount of compounds D) and E) that is sufficient for dispersibility in aqueous media.

In the text below, the novel process for producing a multicoat color and/or effect paint system on a primed or unprimed substrate is referred to for the sake of brevity as the “process of the invention”.

Further subject matter of the invention will emerge from the description.

In the light of the prior art it was surprising and unforeseeable for the skilled worker that the object on which the present invention was based could be achieved by means of the process of the invention. In particular it was surprising that the process of the invention provides multicoat color and/or effect paint systems which, even on substrates of complex shape, are fully cured, highly scratch-resistant, and chemical-resistant. Of particular note is that by means of the process of the invention it is possible to produce multicoat paint systems, including primers where appropriate, exclusively on the basis of aqueous coating materials.

The process of the invention is used to produce multicoat color and/or effect paint systems on primed or unprimed substrates.

Suitable coating substrates are all surfaces which are undamaged by curing of the coatings present thereon using heat; examples include metals, plastics, wood, ceramic, stone, textile, fiber composites, leather, glass, glass fibers, glass wool, rock wool, mineral- and resin-bound building materials, such as plasterboard panels and cement slabs or roof tiles, and also composites of these materials. Accordingly, the process of the invention, is also suitable for applications outside of automotive finishing. In that context it is especially suitable for coating furniture and for industrial coating, including coil coating, container coating, and the impregnation or coating of electrical components. In the context of industrial coatings it is suitable for coating virtually all parts for private or industrial use, such as radiators, domestic appliances, small metal parts such as nuts and bolts, hub caps, wheel rims, packaging, or electrical components such as motor windings or transformer windings.

In the case of electrically conductive substrates it is possible to use primers, which are produced conventionally from electrocoat materials. Both anodic and cathodic electrocoats are suitable for this purpose, but especially cathodics. In the case of metal, the substrate may also have been subjected to a surface treatment, such as a galvanizing or phosphating or Eloxing treatment, for example.

Especially in automotive OEM finishing, a surfacer or an antistonechip primer is applied to the fully cured or merely dried electrocoat. The resulting film is fully cured either on its own or together with the underlying electrocoat film. The applied surfacer film may also be merely dried or partly cured, after which it is fully cured together with the overlying films and also, where appropriate, with the underlying electrocoat film (extended wet-on-wet techniques). In the context of the present invention, the term “primer” also embraces the combination of electrocoat and surfacer or antistonechip primer.

Using the process of the invention it is also possible to coat primed or unprimed plastics such as, for example, ABS, AMMA, ASA, CA, CAB, EP, UF, CF, MF, MPF, PF, PAN, PA, PE, HDPE, LDPE, LLDPE, UHMWPE, PET, PMMA, PP, PS, SB, PUR, PVC, RF, SAN, PBT, PPE, POM, PUR-RIM, SMC, BMC, PP-EPDM, and UP (abbreviations to DIN 7728T1) . The plastics to be coated may of course also be polymer blends, modified plastics or fiber-reinforced plastics. It is also possible to employ the plastics that are commonly used in vehicle construction, especially motor vehicle construction.

Unfunctionalized and/or nonpolar substrate surfaces may be subjected prior to coating in a known manner to a pretreatment, such as with a plasma or by flaming, or may be provided with a water-based primer.

In accordance with the invention, in a first process step a pigmented basecoat material that is curable thermally and also, where appropriate, with actinic radiation, especially an aqueous basecoat material, is applied to the primed or unprimed substrate to give the basecoat film.

Examples of suitable aqueous basecoat materials are known from the patents EP-A-0 089 497, EP-A-0 256 540, EP-A-0 260 447, EP-A-0 297 576, WO 96/12747, EP-A-0 523 610, EP-A-0 228 003, EP-A-0 397 806, EP-A-0 574 417, EP-A-0 531 510, EP-A-0 581 211, EP-A-0 708 788, EP-A-0 593 454, DE-A-43 28 092, EP-A-0 299 148, EP-A-0 394 737, EP-A-0 590 484, EP-A-0 234 362, EP-A-0 234 361, EP-A-0 543 817, WO 95/14721, EP-A-0 521 928, EP-A-0 522 420, EP-A-0 522 419, EP-A-0 649 865, EP-A-0 536 712, EP-A-0 596 460, EP-A-0 596 461, EP-A-0 584 818, EP-A-0 669 356, EP-A-0 634 431, EP-A-0 678 536, EP-A-0 354 261, EP-A-0 424 705, WO 97/49745, WO 97/49747 or EP-A-0 401 565.

The aqueous basecoat material may be applied by any customary application method, such as spraying, knifecoating, brushing, flowcoating, dipping, impregnating, trickling or rolling, for example. The substrate to be coated may itself be at rest, with the application equipment or unit being moved. Alternatively, the substrate to be coated, in particular a coil, may be moved, with the application unit being at rest relative to the substrate or being moved appropriately.

Preference is given to employing spray application methods, such as compressed air spraying, airless spraying, high-speed rotation, electrostatic spray application (ESTA), alone or in conjunction with hot spray application such as hot air spraying, for example. Application may be made at temperatures of max. 70 to 80° C., so that appropriate application viscosities are achieved without any change or damage to the aqueous basecoat material and its overspray (which may be intended for reprocessing) occurring during the short period of thermal stress. For instance, hot spraying may be configured in such a way that the aqueous basecoat material is heated only very briefly in the spray nozzle or shortly before the spray nozzle.

The spray booth used for the application may, for example, be operated with a circulation system which may be temperature-controllable, and which is operated with an appropriate absorption medium for the overspray, an example of such medium being the aqueous basecoat material itself. Preferably, application is conducted under illumination with visible light with a wavelength of more than 550 μm or in the absence of light, if the aqueous basecoat material is curable thermally and with actinic radiation. This prevents material alteration or damage to the basecoat material and the overspray.

Of course, the application methods described above may also be used when producing the other coat films as part of the process of the invention.

In the context of the process of the invention, the aqueous basecoat film, following its application, is cured thermally or both thermally and with actinic radiation. Owing to the large amount of pigments it contains, which strongly absorb and/or scatter the actinic radiation, the aqueous basecoat film is preferably cured thermally. In this case, it is preferred to employ the methods described below of thermal curing, and also, where appropriate, the methods described below of curing with actinic radiation.

In the context of the process of the invention, the thermal cure may be effected immediately following the application of the aqueous basecoat film. If desired, the underlying not yet fully cured films of the primer may also be cured. It is of advantage in accordance with the invention if the primer has already been fully cured prior to the application of the aqueous basecoat material.

In the context of the process of the invention, the aqueous basecoat film is preferably not fully cured but only dried or partly cured. In other words, none of the functional groups present that are capable of thermal crosslinking are reacted, or only some of them are reacted, for instance up to 90 mol %, preferably up to 80 mol %, and in particular up to 70 mol %.

In the process of the invention, the aqueous basecoat film or aqueous basecoat, particularly aqueous basecoat film, is overcoated with a clearcoat film I of a clearcoat material I curable thermally and with actinic radiation. For the process of the invention it is essential to use as clearcoat material I a clearcoat material for inventive use which comprises or consists of an aqueous polyurethane dispersion which contains blocked isocyanate groups, the polyurethane being composed of the starting products that are described below.

In general, the basecoat film and clearcoat film are applied in a wet film thickness such that curing thereof results in coats having the thicknesses which are advantageous and necessary for their functions. In the case of the basecoat this thickness is from 5 to 50 μm, preferably from 5 to 40 μm, with particular preference from 5 to 30 μm, and in particular from 10 to 25 μm, and in the case of the clearcoats is from 10 to 100 μm, preferably from 15 to 80 μm, with particular preference from 20 to 75 μm, and in particular from 25 to 70 μm.

In a first variant of the process of the invention, the clearcoat film I is cured on its own. This presupposes that the underlying coating films have already been fully cured.

In a second, preferred variant of the process of the invention, the clearcoat film I is cured together with the basecoat film.

Curing may take place after a certain rest period. This period may have a duration of from 30 s to 2 h, preferably from 1 min to 1 h, and in particular from 1 min to 45 min. The rest period is used, for example, for leveling and devolatilization of the clearcoat film I and for the evaporation of volatile constituents such as water and any solvents still present. The rest period may be assisted and/or shortened by the application of elevated temperatures up to 90° C. and/or by a reduced air humidity <10 g water/kg air, especially <5 g/kg air, provided this does not entail any damage or alteration to the coating films, such as premature complete crosslinking, for instance.

In a first preferred variant, the clearcoat film I is cured with actinic radiation alone, advantageous technical effects resulting if no photoinitiators are employed in the clearcoat material I. With this variant, the aqueous basecoat film has preferably been already cured fully or at least partly.

In a second preferred variant, the clearcoat film I is cured thermally and with actinic radiation, and no photoinitiator need be present. With this variant, the aqueous basecoat film is preferably uncured or only partly cured.

In another variant, the clearcoat film I is cured by means of heat alone, it being possible to use free-radical polymerization initiators in the clearcoat material I. In the case of this variant, the aqueous basecoat film is preferably uncured or only partly cured.

Curing with actinic radiation is preferably carried out with UV radiation and/or electron beams. In this case it is preferred to employ a dose of from 1000 to 2000, more preferably from 1100 to 1900, with particular preference from 1200 to 1800, with very particular preference from 1300 to 1700, and in particular from 1400 to 1600 mJ/cm². If desired, this curing may be supplemented with actinic radiation from other radiation sources. In the case of electron beams, it is preferred to operate under an inert gas atmosphere. This may be ensured, for example, by supplying carbon dioxide and/or nitrogen directly to the surface of the clearcoat film I. In the case of curing with UV radiation as well it is possible to operate under inert gas in order to prevent the formation of ozone.

Curing with actinic radiation is carried out using the customary and known radiation sources and optical auxiliary measures. Examples of suitable radiation sources are flashlamps from the company VISIT, high or low pressure mercury vapor lamps, with or without lead doping in order to open up a radiation window up to 405 nm, or electron beam sources. Their arrangement is known in principle and may be adapted to the circumstances of the workpiece and the process parameters. In the case of workpieces of complex shape, as are envisaged for automobile bodies, those regions not accessible to direct radiation (shadow regions) such as cavities, folds, and other structural undercuts may be (partly) cured using pointwise, small-area or all-round emitters in conjunction with an automatic movement device for the irradiation of cavities or edges.

The equipment and conditions for these curing methods are described, for example, in R. Holmes, U. V. and E. B. Curing Formulations for Printing Inks, Coatings and Paints, SITA Technology, Academic Press, London, United Kingdom 1984.

Curing in this case may take place in stages, i.e., by multiple exposure to light or actinic radiation. It may also take place alternately, i.e., by curing alternately with UV radiation and electron beams.

Thermal curing as well has no special features in terms of its method but instead takes place in accordance with the customary and known methods such as heating in a forced air oven or irradiation using IR lamps. As is the case with actinic radiation curing, thermal curing may also take place in stages. Thermal curing advantageously takes place at temperatures above 100° C. In general it is advisable not to exceed temperatures of 180° C., preferably 170° C., and in particular 150° C.

Where thermal curing and actinic radiation curing are employed together, these methods may be used simultaneously or alternately. Where the two curing methods are used alternately, it is possible, for example, to begin with thermal curing and end with actinic radiation curing. In other cases it may prove advantageous to begin and to end with actinic radiation curing. Particular advantages result if the clearcoat film I is cured in two separate steps, first with actinic radiation and then thermally.

In the context of the process of the invention, the above-described curing methods may of course also be used to cure the other coating films.

The multicoat color and/or effect paint system resulting from the above-described embodiment of the process of the invention may further be coated with a layer of an organically modified ceramic material, as obtainable commercially, for example, under the brand name Ormocer®.

In one alternative embodiment of the process of the invention, a clearcoat film I of a clearcoat material I curable thermally and/or with actinic radiation is applied to the surface of the basecoat film, especially aqueous basecoat film, and is cured

partly, on its own,

partly, together with the basecoat film,

fully, together with the basecoat film, or

fully, on its own

thermally and/or with actinic radiation, using the methods described in detail above.

Thereafter, a further clearcoat film II of a clearcoat material II curable thermally and/or with actinic radiation is applied to the surface of the clearcoat film I or the clearcoat I, and then

the clearcoat film II, alone or

together with the underlying not yet fully cured coating films

is fully cured thermally and/or with actinic radiation, using the methods described above.

For the further alternative of the process of the invention it is essential that at least one of the clearcoat materials, I or II, is a clearcoat material for inventive use which comprises or consists of an aqueous polyurethane dispersion which contains isocyanate groups and which is composed of the starting products described below and which is therefore curable thermally and with actinic radiation. The other clearcoat material may then be one of the customary and known clearcoat materials described at the outset or a customary and known one-component (1K) clearcoat material as described, for example, in the patents DE-A-42 04 518, U.S. Pat. No. 5,474,811, U.S. Pat. No. 5,356,669, U.S. Pat. No. 5,605,965, WO 94/10211, WO 94/10212, WO 94/10213, EP-A-0 594 068, EP-A-0 594 071, and EP-A-0 594 142. These one-component (1K) clearcoat materials comprise, as is known, hydroxyl-containing binders and crosslinking agents such as blocked polyisocyanates, tris (alkoxycarbonylamino) triazines and/or amino resins. In another variant, they comprise polymer binders containing pendant carbamate and/or allophanate groups, and, where appropriate, carbamate- and/or allophanate-modified amino resin crosslinking agents.

For the process of the invention and the resultant multicoat color and/or effect paint systems it is of advantage if the clearcoat material II comprises a clearcoat material for inventive use.

With this embodiment of the process of the invention as well, the resultant multicoat color and/or effect paint system may further be coated with a layer of an organically modified ceramic material, as is available commercially, for example, under the brand name Ormocer®.

The clearcoat material for use for the process of the invention, curable thermally and with actinic radiation, comprises or consists of an aqueous polyurethane dispersion which contains blocked isocyanate groups. The aqueous polyurethane dispersion, which contains blocked isocyanate groups, contains bonds which can be activated with actinic radiation, isocyanate-reactive functional groups, blocked isocyanate groups, and dispersive functional groups, as essential functional groups. The aqueous polyurethane dispersion for inventive use is therefore self-crosslinking and/or externally crosslinking in the sense mentioned earlier.

For the purposes of the present invention, a bond which can be activated with actinic radiation is a bond which on exposure to actinic radiation becomes reactive and enters, with other activated bonds of its kind, into polymerization reactions and/or crosslinking reactions which proceed in accordance with free-radical and/or ionic mechanisms. Examples of suitable bonds are carbon-hydrogen single bonds or carbon-carbon, carbon-oxygen, carbon-nitrogen, carbon-phosphorus or carbon-silicon single or double bonds. Of these, the carbon-carbon double bonds are particularly advantageous and therefore used with very particular preference in accordance with the invention. For the sake of brevity, they are referred to below as “double bonds”.

Particularly suitable double bonds are present, for example, in (meth)acrylate, ethacrylate, crotonate, cinnamate, vinyl ether, vinyl ester, dicyclopenta-dienyl, norbornenyl, isoprenyl, isopropenyl, allyl or butenyl groups; dicyclopentadienyl ether, norbornenyl ether, isoprenyl ether, isopropenyl ether, allyl ether or butenyl ether groups; or dicyclopentadienyl ester, norbornenyl ester, isoprenyl ester, isopropenyl ester, allyl ester or butenyl ester groups. Of these, the acrylate groups afford very particular advantages and so are used with very particular preference in accordance with the invention.

Examples of suitable isocyanate-reactive functional groups are thio, hydroxyl, amino and/or imino groups, especially thio, hydroxyl and/or amino groups.

The isocyanate groups are preferably blocked with the blocking agents F) known from the U.S. patent U.S. Pat. No. 4,444,954. Examples of suitable blocking agents F) are

i) phenols such as phenol, cresol, xylenol, nitrophenol, chlorophenol, ethylphenol, tert-butylphenol, hydroxybenzoic acid, esters of this acid, or 2,5-di-tert-butyl-4-hydroxytoluene;

ii) lactams, such as ε-caprolactam, δ-valerolactam, γ-butyrolactam or β-propiolactam;

iii) active methylenic compounds, such as diethyl malonate, dimethyl malonate, methyl or ethyl acetoacetate or acetylacetone;

iv) alcohols such as methanol, ethanol, n-propanol, isopropanol, n-butanol, isobutanol, t-butanol, n-amyl alcohol, t-amyl alcohol, lauryl alcohol, ethylene glycol monomethyl ether, ethylene glycol monoethyl ether, ethylene glycol monobutyl ether, diethylene glycol monomethyl ether, diethylene glycol monobutyl ether, propylene glycol monomethyl ether, methoxymethanol, glycolic acid, glycolic esters, lactic acid, lactic esters, methylolurea, methylolmelamine, diacetone alcohol, ethylenechlorohydrin, ethylene bromohydrin, 1,3-dichloro-2-propanol, 1,4-cyclohexyldimethanol or acetocyanohydrin;

v) mercaptans such as butyl mercaptan, hexyl mercaptan, t-butyl mercaptan, t-dodecyl mercaptan, 2-mercaptobenzothiazole, thiophenol, methylthio-phenol or ethylthiophenol;

vi) acid amides such as acetoanilide, aceto-anisidinamide, acrylamide, methacrylamide, acetamide, stearamide or benzamide;

vii) imides such as succinimide, phthalimide or maleimide;

viii) amines such as diphenylamine, phenylnaphthyl-amine, xylidine, N-phenylxylidine, carbazole, aniline, naphthylamine, butylamine, dibutylamine or butylphenylamine;

ix) imidazoles such as imidazole or 2-ethylimidazole;

x) ureas such as urea, thiourea, ethyleneurea, ethylenethiourea or 1,3-diphenylurea;

xi) carbamates such as phenyl N-phenylcarbamate or 2-oxazolidone;

xii) imines such as ethyleneimine;

xiii) oximes such as acetone oxime, formaldoxime, acetaldoxime, acetoxime, methyl ethyl ketoxime, diisobutyl ketoxime, diacetyl monoxime, benzophenone oxime or chlorohexanone oximes;

xiv) salts of sulfurous acids such as sodium bisulfite or potassium bisulfite;

xv) hydroxamic esters such as benzyl methacrylohydroxamate (BMH) or allyl methacrylohydroxamate; or

xvi) substituted pyrazoles, especially dimethylpyrazole or triazoles; and also

xvii) mixtures of these blocking agents, especially dimethylpyrazole and triazoles, malonates and acetoacetates, or dimethylpyrazole and succinimide.

Examples of suitable dispersive functional groups are (potentially) anionic groups such as carboxylic acid, sulfonic acid or phosphonic acid groups, especially carboxylic acid groups. In the polyurethane dispersion for inventive use they are present in an amount such as to result in an acid number of from 5.0 to 100, preferably from 6.0 to 90, more preferably from 7.0 to 80, with particular preference from 8.0 to 70, with very particular preference from 9.0 to 60, and in particular from 10 to 50 mg KOH/g dispersion.

For the process of the invention it is essential that the polyurethane present in the polyurethane dispersion is prepared from the starting products described below in such a way that at least

the above-described dispersive functional groups,

the above-described isocyanate-reactive functional groups, and

the above-described bonds which can be activated with actinic radiation

are present in the polyurethane.

Where only these groups and bonds are present in the polyurethane, the blocked isocyanate groups are introduced into the polyurethane dispersion in the form of blocked polyisocyanates before, during and/or after the preparation of the polyurethane, giving an externally crosslinking polyurethane dispersion.

Examples of suitable blocked polyisocyanates are the polyisocyanates described below in connection with the preparation of the polyurethanes, which polyisocyanates are blocked with the blocking agents F) described above.

In addition to or alternatively to this embodiment the blocked isocyanate groups may be incorporated into the molecule during the preparation of the polyurethane, giving a self-crosslinking polyurethane dispersion or a self-crosslinking and externally crosslinking polyurethane dispersion.

The incorporation of the blocked isocyanate groups into the polyurethanes is accomplished by way of the reaction of at least one of the above-described blocking agents F) for isocyanate groups and/or at least one compound F) containing at least one blocked isocyanate group and one isocyanate-reactive group with the polyurethane prepolymers containing isocyanate groups that result from the reaction of a stoichiometric excess of the compounds A), described below, with the compounds B) and also, where appropriate, C) and G) and also with an amount of compounds D) and E) that is sufficient for dispersibility in aqueous media.

The polyurethane accordingly contains

the above-described dispersive functional groups,

the above-described isocyanate-reactive functional groups,

the above-described bonds which can be activated with actinic radiation, and

the blocked isocyanate groups.

In this case, the polyurethane preferably contains on average

at least one, preferably at least two, and in particular at least three, of the above-described bonds which can be activated with actinic radiation,

at least one, preferably at least two, and in particular at least three of the above-described blocked isocyanate groups, and

at least one, preferably at least two, and in particular at least three of the above-described isocyanate-reactive functional groups.

The second embodiment of the polyurethane, which contains all four of the above-described functional groups, has particular advantages and so is employed with particular preference in accordance with the invention.

In the polyurethane dispersions for inventive use the polyurethane is present preferably in an amount, based on the dispersion, of from 5 to 80%, more preferably from 10 to 70%, with particular preference from 15 to 60%, with very particular preference from 20 to 50%, and in particular from 25 to 40% by weight.

The aqueous polyurethane dispersion or the polyurethane present therein is composed of at least one aliphatic, including cycloaliphatic, polyisocyanate A) having an isocyanate functionality of from 2.0 to 6.0, preferably from 2.0 to 5.0, preferably with 2.0 to 4.5, and in particular from 2.0 to 3.5. For the purposes of the present invention, the term “cycloaliphatic diisocyanate” designates a diisocyanate in which at least one isocyanate group is attached to a cycloaliphatic radical.

Examples of suitable cycloaliphatic polyisocyanates A) having an isocyanate functionality of 2.0 are isophorone diisocyanate (i.e., 5-isocyanato-1-isocyanatomethyl-1,3,3-trimethylcyclohexane), 5-isocyanato-1-(2-isocyanatoeth-1-yl)-1,3,3-trimethylcyclohexane, 5-isocyanato-1-(3-isocyanatoprop-1-yl)-1,3,3-trimethylcyclohexane, 5-isocyanato-(4-isocyanatobut-1-yl)-1,3,3-trimethylcyclohexane, 1-isocyanato-2-(3-isocyanatoprop-1-yl)cyclohexane, 1-isocyanato-2-(3-isocyanatoeth-1-yl)cyclohexane, 1-isocyanato-2-(4-isocyanatobut-1-yl)cyclohexane, 1,2-diisocyanatocyclobutane, 1,3-diisocyanatocyclobutane, 1,2-diisocyanatocyclopentane, 1,3-diisocyanatocyclopentane, 1,2-diisocyanatocyclohexane, 1,3-diisocyanatocyclohexane, 1,4-diisocyanatocyclohexane, dicyclohexylmethane 2,4′-diisocyanate or dicyclohexylmethane 4,4′-diisocyanate, especially isophorone diisocyanate.

Examples of suitable acyclic aliphatic diisocyanates for inventive use are trimethylene diisocyanate, tetramethylene diisocyanate, pentamethylene diisocyanate, hexamethylene diisocyanate, ethylethylene diisocyanate, trimethylhexane diisocyanate, heptamethylene diisocyanate, or diisocyanates derived from dimer fatty acids, as sold under the commercial designation DDI 1410 by Henkel and described in the patents WO 97/49745 and WO 97/49747, especially 2-heptyl-3,4-bis(9-isocyanatononyl)-1-pentylcyclohexane, or 1,2-, 1,4- or 1,3-bis(isocyanatomethyl)cyclo-hexane, 1,2-, 1,4- or 1,3-bis(2-isocyanatoeth-1-yl)cyclohexane, 1,3-bis(3-isocyanatoprop-1-yl)cyclo-hexane or 1,2-, 1,4- or 1,3-bis(4-isocyanatobut-1-yl)-cyclohexane.

Of these, hexamethylene diisocyanate is of particular advantage and is therefore used with very particular preference in accordance with the invention.

Examples of suitable polyisocyanates A) having an isocyanate functionality >2 are polyisocyanates, especially those based on hexamethylene diisocyanate, which contain isocyanurate, biuret, allophanate, iminooxadiazinedione, urethane, urea, carbodiimide and/or uretdione groups and which are obtainable in customary manner from the above-described diisocyanates. Of these, those containing allophanate groups are of advantage and are therefore used with particular preference in accordance with the invention.

Examples of suitable compounds B) containing at least one, especially one, functional group and also at least one bond per molecule which can be activated with actinic radiation are

allyl alcohol or 4-butyl vinyl ether;

hydroxyalkyl esters of acrylic acid or of methacrylic acid, especially of acrylic acid, which are obtainable by esterifying aliphatic diols, examples being the low molecular mass diols B) described above, with acrylic acid or methacrylic acid or by reacting acrylic acid or methacrylic acid with an alkylene oxide, especially hydroxyalkyl esters of acrylic acid or methacrylic acid in which the hydroxyalkyl group contains up to 20 carbon atoms, such as 2-hydroxy-ethyl, 2-hydroxypropyl, 3-hydroxypropyl, 3-hydroxybutyl, 4-hydroxybutyl, bis(hydroxy-methyl)cyclohexane acrylate or methacrylate; of these, 2-hydroxyethyl acrylate and 4-hydroxybutyl acrylate are especially advantageous and are therefore used with particular preference in accordance with the invention; or

reaction products of cyclic esters, such as epsilon-caprolactone, for example, and these hydroxyalkyl or hydroxycycloalkyl esters.

Examples of suitable low molecular mass aliphatic compounds C) containing at least two, especially two, isocyanate-reactive functional groups are polyols, especially diols, polyamines, especially diamines, and amino alcohols. Normally, the polyols and/or polyamines are used alongside the diols and/or diamines in minor amounts in order to introduce branching into the polyurethanes. For the purposes of the present invention, minor amounts are amounts which do not bring about gelling of the polyurethanes during their preparation. For the amino alcohols, this applies mutatis mutandis.

Examples of suitable diols C) are ethylene glycol, 1,2-or 1,3-propanediol, 1,2-, 1,3- or 1,4-butanediol, 1,2-, 1,3-, 1,4- or 1,5-pentanediol, 1,2-, 1,3-, 1,4-, 1,5- or 1,6-hexanediol, neopentyl hydroxypivalate, neopentyl glycol, diethylene glycol, 1,2-, 1,3- or 1,4-cyclo-hexanediol, 1,2-, 1,3- or 1,4-cyclohexanedimethanol, trimethylpentanediol, ethylbutylpropanediol, the positionally isomeric diethyloctanediols, 2-butyl-2-ethyl-1,3-propanediol, 2-butyl-2-methyl-1,3-propane-diol, 2-phenyl-2-methyl-1,3-propanediol, 2-propyl-2-ethyl-1,3-propanediol, 2-di-tert-butyl-1,3-propanediol, 2-butyl-2-propyl-1,3-propanediol, 1-dihydroxymethylbicyclo[2.2.1]heptane, 2,2-diethyl-1,3-propanediol, 2,2-dipropyl-1,3-propanediol, 2-cyclohexyl-2-methyl-1,3-propanediol, 2,5-dimethyl-2,5-hexanediol, 2,5-diethyl-2,5-hexanediol, 2-ethyl-5-methyl-2,5-hexane-diol, 2,4-dimethyl-2,4-pentanediol, 2,3-dimethyl-2,3-butanediol, dihydroxymethylcyclohexane, bis(hydroxy-cyclohexyl)propane, tetramethylcyclobutanediol, cyclooctanediol or norbornanediol.

Examples of suitable polyols C) are trimethylolethane, trimethylpropane or glycerol, pentaerythritol or homo-pentaerythritol or sugar alcohols such as threitol or erythritol or pentitols such as arabitol, adonitol or xylitol, or hexitols such as sorbitol, mannitol or dulcitol.

Examples of suitable diamines C) are hydrazine, ethylenediamine, propylenediamine, 1,4-butylenediamine, piperazine, 1,4-cyclohexyldimethylamine, 1,6-hexamethylenediamine, trimethylhexamethylenediamine, menthanediamine, isophoronediamine or 4,4′-diaminodicyclohexylmethane.

Examples of suitable polyamines C) are diethylenetriamine, triethylenetetramine, dipropylenediamine, and dibutylenetriamine.

Examples of suitable amino alcohols C) are ethanol-amine, diethanolamine, and triethanolamine.

Of these compounds C), diethanolamine affords particular advantages and is therefore used with preference in accordance with the invention.

Examples of suitable compounds D) containing at least one isocyanate-reactive functional group and at least one dispersive functional group, especially a (potentially) anionic group, are mercapto-, hydroxy-, amino- or imino-carboxylic, -phosphonic or -sulfonic acids such as mercaptoacetic acid (thioglycolic acid), mercaptopropionic acid, mercaptosuccinic acid, hydroxyacetic acid, hydroxydecanoic acid, hydroxydodecanoic acid, 12-hydroxystearic acid, hydroxyethanesulfonic acid, hydroxypropanesulfonic acid, mercaptoethanesulfonic acid, mercaptopropanesulfonic acid, aminopropanesulfonic acid, glycine, iminodiacetic acid, 2,2-dimethylolacetic acid, 2,2-dimethylolpropionic acid, 2,2-dimethylolbutyric acid, 2,2-dimethylolpentanoic. acid, α, δ-diaminovaleric acid, 3,4-diaminobenzoic acid, 2,4-,diaminotoluenesulfonic acid or 2,4-diaminodiphenyl ether sulfonic acid. They are used in amounts which result in the acid numbers described above.

Examples of suitable neutralizing agents E) for the potentially anionic groups of compound D) are alkali metal and alkaline earth metal hydroxides, oxides, carbonates or bicarbonates and also ammonia or amines, such as trimethylamine, triethylamine, tributylamine, dimethylaniline, diethylaniline, triphenylamine, di-methylethanolamine, diethylethanolamine, methyl-diethanolamine, 2-aminomethylpropanol, dimethylisopropylamine or dimethylisopropanolamine. The neutralizing agents are preferably employed in an amount so as to give a degree of neutralization of from 10 to 150%, more preferably from 20 to 145%, and in particular from 30 to 140%.

Examples of suitable compounds G) which are different than the compounds B) to F) and contain an isocyanate-reactive functional group are ethanol, propanol, n-butanol, sec-butanol, tert-butanol, amyl alcohols, hexanols, fatty alcohols, phenol, allyl alcohol or ethylhexylamine. They are used preferably in conjunction with compounds C) of higher functionality, particularly in order to prevent the gelling of the polyurethanes in the course of their preparation. The preparation of the polyurethane used in accordance with the invention may be guided so as to result in aqueous polyurethane dispersions which contain liquid particles. The size of the particles may be controlled by way of the amount of acid groups and may vary widely. The particle sizes are preferably from 50 to 1 000 nm, more preferably from 100 to 900 nm, with particular preference from 150 to 800 nm, with very particular preference from 200 to 700 nm, and in particular from 250 to 600 nm.

Alternatively, the nature and amounts of the starting products described above, particularly of the starting products D) and A), may be selected so that, by varying the glass transition temperature and/or acid number of the polyurethanes, finely divided solid particles are obtained, i.e., such that the composition comprises a powder slurry of the invention. These finely divided solid particles preferably have an average size of from 3.0 to 10 μm, in particular from 3.0 to 5 μm. The minimum particle sizes are preferably 0.1, more preferably 0.3 and in particular from 0.5 μm. The maximum particle sizes are 100, preferably 50 and in particular 30 μm.

Viewed in terms of its method, the preparation of the aqueous polyurethane dispersion from the above-described starting products has no special features but instead takes place in accordance with the customary and known methods of preparing aqueous polyurethane dispersions, as described, for example, in the patents cited at the outset which relate to aqueous basecoat materials.

For example, in one preferred procedure, in a first step at least one compound B) is reacted with a molar excess of at least one compound A) to give an adduct containing bonds which can be activated with actinic radiation, and free isocyanate groups. In a second step, the adduct is reacted with at least one compound D) and at least one compound C) to give a prepolymer containing isocyanate groups or an isocyanate-group-free polyurethane. In a further step, at least one neutralizing agent E) and also, where appropriate, at least one compound G) are added so as to give a partially or fully neutralized polyurethane or isocyanate-group-containing prepolymer. The free isocyanate groups of the prepolymer are reacted preferably with at least one compound G) and/or C), thereby forming an optionally chain-extended polyurethane. Before, during and/or after this process at least one blocked polyisocyanate is added. The polyurethane and/or the mixture of polyurethane and blocked polyisocyanate is or are transferred to an aqueous medium, so giving the externally crosslinking polyurethane dispersion for inventive use. If no blocked polyisocyanate has been added to the polyurethane prior to its dispersion, this deficiency is made up for following its dispersion.

In one preferred procedure, the neutralized prepolymer obtained by the process described above is reacted with a blocking agent F) or with a compound F). If it is intended that free isocyanate groups should still be present hereafter, they are preferably reacted with at least one compound G) and/or C), thereby forming an optionally chain-extended polyurethane. The polyurethane is transferred to an aqueous medium, thereby giving the self-crosslinking polyurethane dispersion for inventive use. If a blocked polyisocyanate is also added, a self-crosslinking and externally crosslinking polyurethane dispersion is formed.

The aqueous medium essentially comprises water. The aqueous medium here may include minor amounts of organic solvents, actinic-radiation-curable reactive diluents, photoinitiators, free-radical polymerization initiators, Theological aids or thickeners and/or other customary coatings additives and/or other dissolved solid, liquid or gaseous organic and/or inorganic substances of low and/or high molecular mass. For the purposes of the present invention, the term “minor amount” refers to an amount which does not remove the aqueous nature of the aqueous medium. Alternatively, the aqueous medium may comprise straight water.

Suitable radiation-curable reactive diluents include low molecular mass polyfunctional ethylenically unsaturated compounds. Examples of suitable compounds of this kind are esters of acrylic acid with polyols, such as neopentyl glycol diacrylate, trimethylolpropane triacrylate, pentaerythritol triacrylate or penta-erythritol tetraacrylate; or reaction products of hydroxyalkyl acrylates with polyisocyanates, especially aliphatic polyisocyanates. For further details, refer to Römpp Lexikon Lacke und Druckfarben, Georg Thieme Verlag, Stuttgart, New York, 1998 “reactive diluents”, page 491.

Where photoinitiators are used, they are present in the polyurethane dispersion for inventive use preferably in fractions of from 0.1 to 10% by weight, more preferably from 1 to 8% by weight, and in particular from 2 to 6% by weight, based in each case on the overall amount of the dispersion.

Examples of suitable photoinitiators are those of the Norrish II type, whose mechanism of action is based on an intramolecular variant of the hydrogen abstraction reactions such as occur diversely in photochemical reactions (reference may be made here, by way of example, to Römpp Chemie Lexikon, 9th, extended and revised edition, Georg Thieme Verlag Stuttgart, Vol. 4, 1991) or cationic photoinitiators (reference may be made here, by way of example, to Römpp Lexikon Lacke und Druckfarben, Georg Thieme Verlag Stuttgart, 1998, pages 444 to 446), especially benzophenones, benzoins or benzoin ethers, or phosphine oxides. It is also possible to use, for example, the products available commercially under the names Irgacure® 184, Irgacure® 1800, and Irgacure® 500 from Ciba Geigy, Genocure® MBF from Rahn, and Lucirin® TPO from BASF AG.

Besides the photoinitiators, customary sensitizers such as anthracene may be used, in effective amounts.

Furthermore, the polyurethane dispersion of the invention may also include at least one thermal crosslinking initiator. At from 80 to 120° C., these initiators form free radicals which start the crosslinking reaction. Examples of thermolabile free-radical initiators are organic peroxides, organic azo compounds or C-C cleaving initiators such as dialkyl peroxides, peroxocarboxylic acids, peroxodicarbonates, peroxide esters, hydroperoxides, ketone peroxides, azodinitriles or benzpinacol silyl ethers. C-C-cleaving initiators are particularly preferred since their thermal cleavage does not produce any gaseous decomposition products which might lead to defects in the coating film. Where used, their amounts are generally from 0.1 to 10% by weight, preferably from 0.5 to 8% by weight, and in particular from 1 to 5% by weight, based in each case on the overall amount of the dispersion.

Suitable Theological aids or thickeners are those known from the patents WO 94/22968, EP-A-0 276 501, EP-A-0 249 201 or WO 97/12945; crosslinked polymeric microparticles, as disclosed, for example, in EP-A-0 008 127; inorganic phyllosilicates such as aluminum magnesium silicates, sodium magnesium phyllosilicates and sodium magnesium fluorine lithium phyllosilicates of the montmorillonite type; silicas such as Aerosils; synthetic polymers containing ionic and/or associative groups, such as polyvinyl alcohol, poly(meth)acrylamide, poly(meth)acrylic acid, polyvinylpyrrolidone, styrene-maleic anhydride copolymers or ethylene-maleic anhydride copolymers and their derivatives; associative thickeners based on glylolurils; or polyurethane-based associative thickeners, as described in Römpp Lexikon Lacke und Druckfarben, Georg Thieme Verlag, Stuttgart, New York, 1998, “Thickeners”, pages 599 to 600, and in the textbook “Lackadditive” by Johan Bielemann, Wiley-VCH, Weinheim, N.Y., 1998, pages 51 to 59 and 65; especially combinations of ionic and nonionic thickeners, as described in patent application DE 198 41 842 for setting a pseudoplastic behavior, or the combination of associative thickeners based on polyurethane and wetting agents based on polyurethane, as described in detail in the German patent application DE 198 35 296 A-1.

Examples of suitable further customary coatings additives are transparent organic and inorganic fillers, thermally curable reactive diluents, low-boiling and/or high-boiling organic solvents (“long solvents”), UV absorbers, light stabilizers, free-radical scavengers, crosslinking catalysts, devolatilizers, slip additives, polymerization inhibitors, defoamers, emulsifiers, wetting agents, adhesion promoters, leveling agents, film formation auxiliaries, and flame retardants. Further examples of suitable coatings additives are described in the textbook “Lackadditive” [Additives for coatings] by Johan Bieleman, Wiley-VCH, Weinheim, N.Y., 1998. They are employed in the customary and known, effective amounts.

It is preferred to select those aforementioned additives which are compatible with water and in particular are not decomposed by water.

The multicoat color and/or effect paint systems produced by means of the process of the invention are of the utmost optical quality as regards color, effect, gloss, and DOI (distinctness of the reflected image), have a smooth, structureless, hard, flexible, and scratch-resistant surface, are stable to weathering, chemicals, and etching, do not yellow, and do not exhibit any cracking or delamination of the coats.

The primed or unprimed substrates coated with these multicoat color and/or effect paint systems therefore have a particularly long service life and a particularly high utility, so making them especially attractive both technically and economically for manufacturers, processors, and end users.

### EXAMPLE

The production of a multicoat color paint system by the process of the invention

1. The Preparation of an Allophanate from Hexamethylene Diisocyanate and 2-hydroxyethyl Acrylate

The allophanate was prepared in accordance with the German patent DE-A-198 60 041, experimental section 1.1, product 6. This was done by mixing hexamethylene diisocyanate under nitrogen with 40 mol % (based on the isocyanate) of 2-hydroxyethyl acrylate and heating the mixture to 80° C. Following the addition of 200 ppm by weight (based on the isocyanate) of N,N,N-trimethyl-N-(2-hydroxypropyl)ammonium 2-ethylhexanoate, the reaction mixture was slowly heated to 120° C. and held at this reaction temperature. At a reaction mixture isocyanate content of 13.5% by weight, the reaction was stopped by adding 250 ppm by weight (based on the isocyanate) of di-(2-ethylhexyl)phosphate. The reaction mixture was then freed from unreacted hexamethylene diisocyanate in a thin-film evaporator at 135° C. and 2.5 mbar. Following distillation, the resultant allophanate had an isocyanate content of 13.5% by weight and a viscosity of 810 mPas at 23° C.

2. The Preparation of an Isocyanato-functional Prepolymer

A stirred vessel was charged with 100 parts by weight of the above-described allophanate (cf. section 1.), 0.13 part by weight of 2,6-di-tert-butyl-p-cresol and 0.1 part by weight of hydroquinone monomethyl ether. Following the addition of 0.02 part by weight of dibutyltin dilaurate and 17.5 parts by weight of 3,5-dimethylpyrazole, the reaction mixture was stirred at 70° C. for three hours.

3. The Preparation of the Aqueous Polyurethane Dispersion

3.3 parts by weight of thioglycolic acid were added to the reaction mixture resulting from section 2. The reaction mixture was then stirred at 70° C. for three hours more and subsequently cooled. The amount of free isocyanate groups after this was 3% by weight. Following the addition of 9.6 parts by weight of diethanolamine and 4.4 parts by weight of triethylamine (in accordance with a degree of neutralization of 120%), the reaction mixture was dispersed in water. This gave a stable dispersion having a z-average particle size of 320 nm (measured with a PCS Malvern Zetasizer 1000) and an acid number of 6 mg KOH/g dispersion or 13 mg KOH/g solids.

For application, the dispersion was adjusted to a solids content of 30% by weight (1 hour; 130° C.).

4. The Preparation of a Clearcoat Material for Inventive Use

100 parts by weight of the dispersion prepared in accordance with section 3. was intimately mixed with 0.1 part by weight of a commercial leveling agent (BYK® 307 from Byk Chemie), 4.0 parts by weight of a commercial photoinitiator (Genocure® MBF from Rahn Chemie), 1.0 part by weight of a commercial UV absorber (Tinuvin® 1130 from Ciba Specialty Chemicals) and 0.8 part by weight of a sterically hindered amine (HALS) (Tinuvin® 292 from Ciba Specialty Chemicals). After this, the clearcoat material was ready for spraying.

5. The Production of the Multicoat Color Paint System

Using a cup-type gun, first of all a commercial aqueous surfacer (Ecoprime® R130 from BASF Coatings AG) was applied to and baked on steel panels coated cathodically (electrocoat with a coat thickness of 18-22 μm) with a commercial electrocoat material (Cathoguard® 500 from BASF Coatings AG) . This gave a surfacer coat having a thickness of from 35 to 40 μm. Thereafter, a black aqueous basecoat material (Basislack nachtschwarz FV96-9400 from BASF Coatings AG) was applied to the surfacer in the same way and dried at 80° C. for 10 minutes. After the panels had cooled, a film of the clearcoat material prepared in accordance with section 4. was applied in a wet film thickness of 150 μm using a cup-type gun, and was flashed off at room temperature for 10 minutes and dried at 80° C. for 5 minutes (wet-on-wet technique).

The test panels were then irradiated with UV radiation, using a dose of 1500 mJ/cm². Thereafter they were baked at 150° C. for 30 minutes (dual cure) . The result was a basecoat with a thickness of 16 μm and a clearcoat with a thickness of 45 μm.

The multicoat system produced with the process of the invention had a high gloss of 87° in accordance with DIN 67530 and a high level of hardness (König pendulum hardness: 195 s).

The scratch resistance of the multicoat system was determined in accordance with the brush test. For this test, the test panels were stored at room temperature for at least two weeks following application of the multicoat system, before the test was carried out.

The scratch resistance was assessed using the BASF brush test described in FIG. 2 on page 28 of the article by P. Betz and A. Bartelt, Progress in Organic Coatings, 22 (1993), pages 27-37, albeit with a modification in respect of the weight used (2000 g instead of the 280 g specified therein), assessment taking place as follows:

In the test, the film surface was damaged with a woven mesh which was loaded with a weight. The woven mesh and the film surface were wetted generously with a laundry detergent solution. By means of a motor drive, the test panel was moved backward and forward under the woven mesh in reciprocating movements.

The test element was an eraser (4.5×2.0 cm, broad side perpendicular to the direction of scratching) around which was stretched a woven nylon mesh (No. 11, 31 μm mesh size, Tg 50° C.). The applied weight was 2000 g.

Prior to each test, the woven mesh was replaced, with the running direction of the woven meshes parallel to the direction of scratching. Using a pipette, about 1 ml of a freshly stirred 0.25% Persil solution was applied before the eraser. The speed of rotation of the motor was set so as to perform 80 double strokes within a period of 80 s. After the test, the remaining detergent liquid was rinsed off with cold tap water and the test panels were blown dry with compressed air. Measurements were made of the gloss to DIN 67530 before and after damage (measurement direction perpendicular to the direction of scratching):

| | |
|---|---|
| Initial: | 87° |
| After damage: | 81° |
| 2 h at 40° C.: | 84° |
| 2 h at 60° C.: | 86° |

The brush test showed that the multicoat system exhibited high scratch resistance and very good reflow behavior.

In addition, the scratch resistance was determined by the sand test. For this purpose, the film surface was loaded with sand (20 g of quartz silver sand, 1.5-2.0 mm). The sand was placed in a beaker (with its base cut off in a planar fashion) which was firmly fastened on the test panel. The test panels used were the same as those described in the brush test above. Using a motor drive, the panel with the beaker and the sand was set in shaking movements. The movement of the loose sand damaged the film surface (100 double strokes in 20 s). Following sand exposure, the test area was cleaned to remove abraided material, wiped off carefully under a jet of cold water, and then dried with compressed air. Measurements were made of the gloss to DIN 67530 before and after damage (measurement direction perpendicular to the direction of scratching):

| | |
|---|---|
| Initial: | 87° |
| After damage: | 80° |
| 2 h at 40° C.: | 82° |
| 2 h at 60° C.: | 85° |

The sand test underscored the high scratch resistance and very good reflow behavior of the multicoat system.

The BART (BASF ACID RESISTANCE TEST) was used to determine the resistance of the film surface to acids, alkalis and water droplets. The multicoat system was exposed to further temperature loads in a gradient oven (30 min at 40° C. and 70° C.). Beforehand the test substances (1%, 10% and 36% sulfuric acid; 6% sulfurous acid, 10% hydrochloric acid, 5% sodium hydroxide solution; DI (dionized) water—1, 2 or 3 drops) were applied in a defined manner using a volumetric pipette. Following exposure to the substances, the substances were removed under running water and the damage was assessed visually after 24 h in accordance with a defined scale:

| Rating | Appearance |
|---|---|
| 0 | no defect |
| 1 | slight marking |
| 2 | marking/matting/no softening |
| 3 | marking/matting/color change/softening |
| 4 | cracks/incipient etching |
| 5 | clearcoat removed |

Each individual mark (spot) was evaluated and the result was set down in an appropriate form (e.g., ratings totals for one temperature).

The results of the test are given in the table:

TABLE
The BART acid resistance of the multicoat system
Example

| | | |
|---|---|---|
| Temperature (° C.) | 40 | 70 |
| H₂SO₄ 1% | 0 | 4.5 |
| H₂SO₄ 10% | 0 | 5.0 |
| H₂SO₄ 36% | 1 | 5.0 |
| HCl 10% | 0 | 1.5 |
| H₂SO₃ 5% | 0 | 3.0 |
| NaOH 5% | 0 | 0 |
| DI water 1 | 0 | 0 |
| DI water 2 | 0 | 0 |
| DI water 3 | 0 | 0 |
| Total acid: | 1.5 | 19 |
| Total water: | 0 | 0 |

The BART underscored the high acid resistance of the multicoat system and, respectively, of the clearcoat.

powder slurry and process for producing a multicoat color and/or effect paint system on a primed or unprimed substrate

what is claimed is:

1. A process for producing a multicoat color and/or effect paint system on a primed or unprimed substrate wherein a basecoat film and at least one clearcoat film are applied one atop the other, characterized in that at least one of the clearcoat materials is curable thermally and with actinic radiation and comprises or consists of at least one aqueous polyurethane dispersion which contains blocked isocyanate groups and which has an acid number of from 5.0 to 100 mg KOH/g dispersion, the polyurethane contained in the polyurethane dispersion being composed of
A) at least one aliphatic polyisocyanate having an isocyanate functionality of from 2.0 to 6.0,
B) at least one compound containing at least one isocyanate-reactive functional group and at least one bond which can be activated with actinic radiation,
C) at least one low molecular mass aliphatic compound containing at least two isocyanate-reactive functional groups,
D) at least one compound containing at least one isocyanate-reactive functional group and at least one dispersive functional group,
E) at least one neutralizing agent for the dispersive functional groups of the compound D), and, if desired,
G) at least one compound other than compounds B) to
E), containing an isocyanate-reactive functional group,
and the blocked isocyanate groups being introduced into the polyurethane dispersion
1. by adding at least one blocked polyisocyanate before, during and/or after the preparation of the polyurethane and/or
2. by way of the reaction of at least one blocking agent F) for isocyanate groups and/or at least one compound F) containing at least one blocked isocyanate group and one isocyanate-reactive group with the polyurethane prepolymers containing isocyanate groups that result from the reaction of a stoichiometric excess of the compounds A) with the compounds B) and also, where appropriate, C) and G) and also with an amount of compounds D) and E) that is sufficient for dispersibility in aqueous media.

2. A powder slurry curable thermally and with actinic radiation, consisting of or comprising at least one aqueous polyurethane dispersion comprising finely divided solid particles, characterized in that the polyurethane dispersion has an acid number of from 5.0 to 100 mg KOH/g dispersion and contains blocked isocyanate groups, the polyurethane contained in the polyurethane dispersion being composed of
A) at least one aliphatic polyisocyanate having an isocyanate functionality of from 2.0 to 6.0,
B) at least one compound containing at least one isocyanate-reactive functional group and at least one bond which can be activated with actinic radiation,
C) at least one low molecular mass aliphatic compound containing at least two isocyanate-reactive functional groups,
D) at least one compound containing at least one isocyanate-reactive functional group and at least one dispersive functional group,
E) at least one neutralizing agent for the dispersive functional groups of the compound D), and, if desired,
G) at least one compound other than compounds B) to
E), containing an isocyanate-reactive functional group,
and the blocked isocyanate groups being introduced into the polyurethane dispersion
1. by adding at least one blocked polyisocyanate before, during and/or after the preparation of the polyurethane and/or
2. by way of the reaction of at least one blocking agent F) for isocyanate groups and/or at least one compound F) containing at least one blocked isocyanate group and one isocyanate-reactive group with the polyurethane prepolymers containing isocyanate groups that result from the reaction of a stoichiometric excess of the compounds A) with the compounds B) and also, where appropriate, C) and G) and also with an amount of compounds D) and E) that is sufficient for dispersibility in aqueous media.

3. The process as claimed in claim 1, characterized in that
(1) a film of a pigmented basecoat material curable thermally and also, where appropriate, with actinic radiation is applied to the surface of the substrate and,
(1.1) without being cured, is dried or partly cured or
(1.2) is fully cured thermally and, where appropriate, with actinic radiation, and then
(2) a clearcoat film I of the clearcoat material I curable thermally and with actinic radiation is applied to the surface of the basecoat film or the basecoat and is fully cured
(2.1) together with the basecoat film or
(2.2) on its own
thermally and/or with actinic radiation; or alternatively
(2) a clearcoat film I of a clearcoat material I curable thermally and/or with actinic radiation is applied to the surface of the basecoat film or the basecoat and is cured
(2.1) partly, on its own,
(2.2) partly, together with the basecoat film or
(2.3) fully, together with the basecoat film, or
(2.4) fully, on its own
thermally and/or with actinic radiation, and then
(3) a further clearcoat film II of a clearcoat material II curable thermally and/or with actinic radiation is applied to the surface of the clearcoat film I or the clearcoat I, at least one of the clearcoat films I and II being of a clearcoat material curable thermally and with actinic radiation, and then
(3.1) the clearcoat film II is fully cured alone or
(3.2) together with the underlying not yet fully cured coating films
thermally and/or with actinic radiation.

4. The process as claimed in claim 1 or 3, characterized in that the polyurethane present in the polyurethane dispersion contains bonds which can be activated with actinic radiation, isocyanate-reactive functional groups, blocked isocyanate groups, and dispersive functional groups, especially (partially) anionic groups.

5. The process as claimed in any of claims 1, 3 or 4 and the powder slurry as claimed in claim 2 or 4, characterized in that aliphatic polyisocyanates containing isocyanurate, biuret, allophanate, iminooxadiazinedione, urethane, urea, carbodiimide and/or uretdione groups are used as compounds A).

6. The process as claimed in any of claims 1 or 3 to 5 and the powder slurry as claimed in any of claims 2, 4 or 5, characterized in that said bonds which can be activated with actinic radiation comprise carbon-hydrogen single bonds or carbon-carbon, carbon-oxygen, carbon-nitrogen, carbon-phosphorus or carbon-silicon single bonds or double bonds.

7. The process and the powder slurry as claimed in claim 6, characterized in that the double bonds are in the form of (meth)acrylate, ethacrylate, crotonate, cinnamate, vinyl ether, vinyl ester, dicyclopentadienyl, norbornenyl, isoprenyl, isopropenyl, allyl or butenyl groups; dicyclopentadienyl ether, norbornenyl ether, isoprenyl ether, isopropenyl ether, allyl ether or butenyl ether groups; or dicyclopentadienyl ester, norbornenyl ester, isoprenyl ester, isopropenyl ester, allyl ester or butenyl ester groups.

8. The process as claimed in any of claims 1 or 3 to 7 and the powder slurry as claimed in any of claims 2 or 4 to 7, characterized in that said isocyanate-reactive functional groups comprise thio, hydroxyl, amino, imino, carbamate and/or allophanate groups, especially thio, hydroxyl, and amino groups.

9. The process as claimed in any of claims 1 or 3 to 8 and the powder slurry as claimed in any of claims 2 or 4 to 8, characterized in that said (potentially) anionic groups comprise carboxylic acid, sulfonic acid or phosphonic acid groups, especially carboxylic acid groups.

10. The process as claimed in any of claims 1 or 3 to 9 and the powder slurry as claimed in any of claims 2 or 4 to 9, characterized in that said blocking agents comprise oximes and/or substituted pyrazoles, especially ketoximes and/or dimethylpyrazole.

11. The process as claimed in any of claims 1 or 3 to 10 and the powder slurry as claimed in any of claims 2 or 4 to 10, characterized in that at least one of the clearcoat materials I and/or II comprises at least one photoinitiator, at least one reactive diluent for curing with actinic radiation, at least one thermal crosslinking initiator and/or at least one customary coatings additive.

12. A multicoat color and/or effect paint system on a primed or unprimed substrate, producible by means of the process as claimed in any of claims 1 or 3 to 11 and/or by means of the powder slurry as claimed in any of claims 2 or 4 to 11.
